(19) United States
(12) Patent Application Publication
(10) Pub. No.: US 2016/0370619 A1
(43) Pub. Date: Dec. 22, 2016

(54) DISPLAY PANEL AND METHOD FOR FABRICATING THE SAME

(71) Applicant: InnoLux Corporation, Miao-Li County (TW)

(72) Inventors: Chung-Jun KUO, Miao-Li County (TW); Bi-Ly LIN, Miao-Li County (TW); Pei-Chun CHEN, Miao-Li County (TW)

(21) Appl. No.: 15/161,388

(22) Filed: May 23, 2016

(30) Foreign Application Priority Data
Jun. 19, 2015 (CN) 201510344245.0

(51) Int. Cl. G02F 1/1339; G02F 1/1337

(52) U.S. Cl. CPC G02F 1/1339; G02F 1/1337; G02F 1/13392

(57) ABSTRACT

According to an embodiment, a method for fabricating a display panel comprising forming a cover layer on a display region and a periphery region of a substrate, irradiating the cover layer with UV light corresponding to the display region but not irradiating the cover layer with the UV light corresponding to all or a portion of a seal region in the periphery region, and forming an alignment layer on the cover layer corresponding to at least the display region. In an embodiment, a display panel comprises at least one bump on the periphery region. A material of the alignment layer and a material of the at least one bump are the same. In another embodiment, the display panel comprises the alignment layer on the cover layer corresponding to the display region and further on the periphery region other than the seal region.

### CROSS-REFERENCE TO RELATED APPLICATIONS

This application claims the benefits of a foreign priority application filed in China as Serial No. 201510344245.0 on Jun. 19, 2015, the subject matter of which is incorporated herein by reference.

### BACKGROUND OF THE INVENTION

1. Field of the Invention

The present invention relates to a method for fabricating a display panel, and particularly, an example embodiment of the present invention relates to a method for fabricating a display panel comprising an improved sealing process. An example embodiment of the present invention also relates to a display panel fabricated by the method.

2. Description of the Related Art

With the development of electronic products in recent years, liquid crystal display devices have been widely used in a variety of related electronic products, such as smart phones, tablet PCs, notebook computers, televisions, car dashboards, etc. In addition to the functions, the display quality of these devices is important to users. Many factors affect display quality and one of the factors is the sealing process of substrate assembling during the fabrication of display device.

In a conventional process for fabricating a display device, when an alignment layer is formed on a display region of a substrate by coating a polyimide material, the polyimide material tends to overflow and extend to a periphery region of the substrate, and moreover, to a predetermined seal region in the periphery region. The overflowed polyimide material eventually becomes an extended portion of the alignment layer. A sealant is then overlapped with the extended portion of the alignment layer. Such overlap prevents the sealant from directly adhere to a predetermined material during a subsequent substrate assembling process. The overlap between the sealant and the extended portion of the alignment layer can be easily detached by external force, which results in one or more breaches for air or water vapor to easily enter the gap of the display panel and form bubbles or mura phenomena.

Accordingly, a novel fabrication method for display panel is needed to prevent the alignment layer from extending outward to the predetermined seal region to overlap with the sealant and affects the sealing reliability.

### SUMMARY OF THE INVENTION

An example embodiment of the present invention is to provide a method for fabricating a display panel, in which a cover layer corresponding to a seal region exhibits good adhesion to a sealant.

According to one embodiment of the present invention, a method for fabricating a display panel is provided. The method comprises providing a substrate comprising a display region and a periphery region, wherein the periphery region is outside the display region and the periphery region comprises a seal region; forming a cover layer on the display region and the periphery region of the substrate; irradiating the cover layer with UV light (ultraviolet ray) corresponding to the display region but not irradiating the cover layer with the UV light corresponding to all or a portion of the seal region; and forming an alignment layer on the cover layer corresponding to at least the display region.

In an embodiment of the present invention, the cover layer corresponding to the entire seal region is not irradiated with the UV light.

In an embodiment of the present invention, the cover layer corresponding to the periphery region is not irradiated with the UV light.

In an embodiment of the present invention, after forming the alignment layer, further comprising: disposing a sealant on the cover layer corresponding to the seal region.

In an embodiment of the present invention, the alignment layer is further formed on the periphery region other than the seal region.

In an embodiment of the present invention, when the alignment layer is formed on the cover layer corresponding to at least the display region, at least one bump is further form on the seal region and a material of the alignment layer and a material of the at least one bump are the same.

According to one embodiment of the present invention, a display panel is provided. The display panel comprises a substrate, a cover layer, an alignment layer, at least one bump, and a sealant. The substrate comprises a display region and a periphery region, wherein the periphery region is outside of the display region and the periphery region comprises a seal region. The cover layer is on the display region and the periphery region of the substrate. The alignment layer is on the cover layer corresponding to the display region. The at least one bump is on the periphery region, and a material of the alignment layer and a material of the at least one bump are the same. The sealant is on the cover layer corresponding to the seal region.

In an embodiment of the present invention, the sealant of the display panel may further cover all or a part of the at least one bump. The at least one bump is one or a plurality of dots, or irregular-shaped fragments, or a combination thereof.

According to another embodiment of the present invention, a display panel is provided. The display panel comprises a substrate, a cover layer, an alignment layer, and a sealant. The substrate comprises a display region and a periphery region, wherein the periphery region is outside the display region and the periphery region comprises a seal region. The cover layer is on the display region and the periphery region of the substrate. The alignment layer is on the cover layer corresponding to the display region and further on the periphery region other than the seal region. The sealant is on the cover layer corresponding to the seal region.

In an embodiment of the present invention, the display panel further comprises at least one bump on the seal region, wherein a material of the alignment layer and a material of the at least one bump are the same, and the sealant further covers the at least one bump. The at least one bump is one or a plurality of dots, or irregular-shaped fragments, or a combination thereof.

Accordingly, in an embodiment of the method for fabricating a display panel provided in the present invention, since the cover layer corresponding to the seal region is not irradiated with the UV light, the material of the alignment layer may not be easily adhered thereto. Consequently, the alignment layer may be formed conveniently while the sealant on the cover layer corresponding to the seal region can still have good sealing quality.

### BRIEF DESCRIPTION OF THE DRAWINGS

FIG. 1 is a schematic diagram showing a cross-sectional view of a display panel according to an embodiment of the present invention;

FIGS. 2 to 5 are schematic diagrams showing top views of a fabrication method of a display panel according to an embodiment of the present invention;

FIG. 6 is a schematic diagram showing a top view of a fabrication method of a display panel according to an embodiment of the present invention;

FIGS. 7 and 8 are schematic diagrams showing top views of a fabrication method of a display panel according to an embodiment of the present invention;

FIG. 9 is a schematic diagram showing a top view of a fabrication method of a display panel according to an embodiment of the present invention; and

FIG. 10 is a schematic diagram showing a top view of a fabrication method of a display panel according to an embodiment of the present invention.

### DETAILED DESCRIPTION OF THE PREFERRED EMBODIMENT

The following describes the detail of the present invention in accordance with certain embodiments. Those skilled in the art can easily understand other advantages and functions of the present invention by the disclosure of the specification. The present invention can also be performed or practiced by other different embodiments. Regarding different views and applications, numerous variations and modifications can be made from the detail of the specification without departing from the spirit of the present invention.

### Embodiment 1

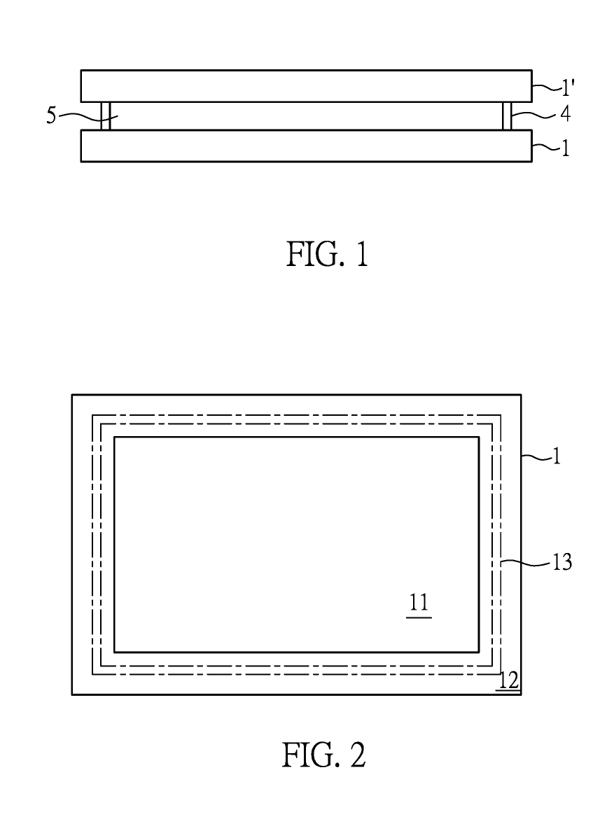

FIG. 1 is a schematic diagram showing a cross-sectional view of a display panel according to an embodiment of the present invention. The display panel includes a substrate 1; an oppositely-disposed substrate 1′ facing the substrate 1; a sealant 4 disposed between the substrate 1 and the oppositely-disposed substrate 1′, and disposed on periphery regions of the substrate 1 and the oppositely-disposed substrate 1′; and a display media layer 5, such as a liquid crystal layer, distributed between the substrate 1 and the oppositely-disposed substrate 1′, and disposed within a region surrounded by the sealant 4. The substrate 1 and the oppositely-disposed substrate 1′ may each be a substrate, such as a glass substrate, a plastic substrate, and the like, which is usually used in this technical field. In addition, a thin film transistor (TFT) array may be formed on one of the substrate 1 and the oppositely-disposed substrate 1′ to serve as a TFT substrate. A color filter (CF) layer may be formed on the other substrate to serve as a CF substrate. The TFT array and the CF layer may even be formed and integrated on either one of the substrate 1 or the oppositely-disposed substrate 1′ to serve as a color filter on array (COA) substrate.

FIGS. 2 to 5 are schematic diagrams showing top views of a fabrication method of a display panel according to an embodiment of the present invention. Since both of the substrate 1 and the oppositely-disposed substrate 1′ can be made using the fabrication method described as follows, only the fabrication of the substrate 1 is described herein. The following steps are included in the method for fabricating a display panel shown in FIGS. 2 to 5. First, referring to FIG. 2, a substrate 1 is provided. The substrate 1 includes a display region 11 and a periphery region 12, wherein the periphery region 12 is disposed outside the display region 11 and the periphery region 12 comprises a seal region 13. Usually, the display region 11 may include a plurality of pixel units (not shown) for displaying images. The periphery region 12 usually surrounds the display region 11, where peripheral electric circuits (but not limited thereto) are disposed. The seal region 13 is located in the periphery region 12 and a sealant will be applied accordingly to the seal region 13 in a subsequent process of substrate assembling.

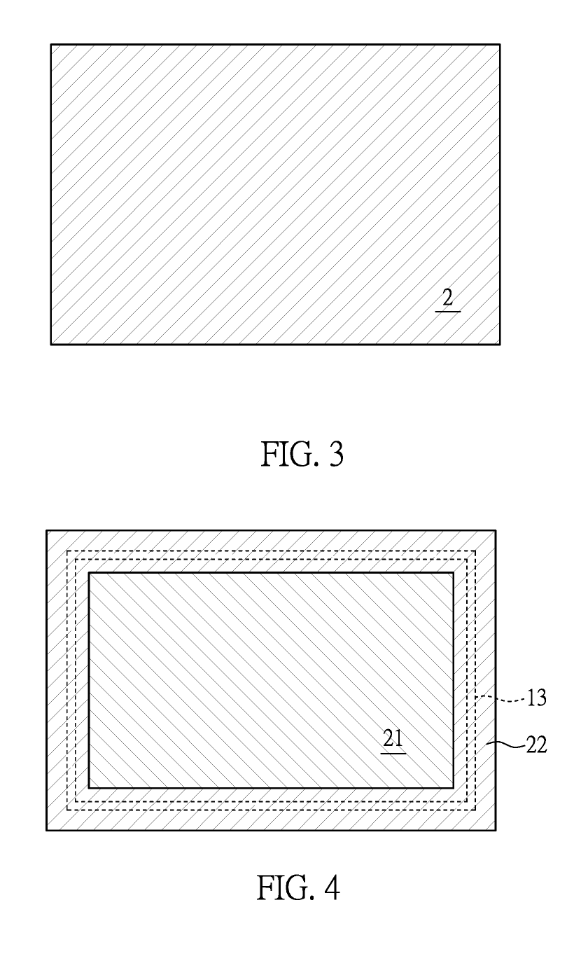

Next, referring to FIGS. 2 and 3, a cover layer 2 is formed on the display region 11 and the periphery region 12 of the substrate 1. The cover layer 2 covers the substrate 1 for protection and further for flatness. The cover layer 2 may include conventional materials, such as an organic layer formed from, for example, acrylic material, silane material or the like. The contact angle of the alignment material composition on the cover layer before irradiating with UV light is too big to allow the alignment material composition to adhere easily to the cover layer. After irradiating with the UV light, the contact angle becomes smaller and the alignment material composition can adhere well to the cover layer. The cover layer may be formed using a conventional technology, for example, but not limited to, transfer printing, to apply the cover layer material on the substrate 1 to form the cover layer 2. Further detail is not described herein for conciseness.

Next, referring to FIGS. 2 to 4, the cover layer 2 is partially irradiated with UV light. The cover layer 2 corresponding to the display region 11 is irradiated with the UV light; however, the cover layer 2 corresponding to the entire periphery region 12, comprising the seal region 13, is not irradiated with the UV light. In other words, this is also an embodiment in which the cover layer 2 corresponding to the entire seal region 13 is not irradiated with the UV light as shown in FIG. 4. In an embodiment of the present invention, since the cover layer 2 corresponding to the display region 11 is irradiated with the UV light, the wettability of a surface of the cover layer 2 is changed. The contact angle can be reduced with improved adherence to allow the alignment material composition applied later to the cover layer to be able to adhere tightly thereto. The portion of the cover layer 2 irradiated with the UV light is referred to as “the cover layer 21” and the portion of the cover layer 2 not irradiated with the UV light is referred to as “the cover layer 22”. The cover layer 22 comprises the cover layer corresponding to the seal region 13. With respect to the cover layer 22 not irradiated with the UV light, the contact angle of the alignment material composition on the cover layer remains big and the adhesion of the alignment material composition to the cover layer is poor. In the present invention, the area not irradiated with the UV light is not limited to that shown in FIG. 4, but it can also be the cover layer 2 corresponding to a portion of or the entire seal region 13. According to an embodiment of the present invention, situations when the cover layer 2 corresponding to a portion of or the entire seal region 13 is not irradiated with the UV light may include the following: the cover layer 2 corresponding to the entire periphery region 12, including a portion of or the entire seal region 13, is not irradiated with the UV light; or the cover layer 2 corresponding to a portion of the periphery region 12, including a portion of or the entire seal region 13, is not irradiated with the UV light; or the cover layer 2 corresponding to only a portion of or the entire seal region 13 is not irradiated with the UV light. In one of the embodiments, for example, FIG. 3 shows an embodiment in which the cover layer 2 corresponding to the entire periphery region 12, including the seal region 13, is not irradiated with the UV light. This is also an embodiment in which the cover layer 2 corresponding to the entire seal region 13 is not irradiated with the UV light.

The UV light used to irradiate the cover layer 2 may depend on the material of the cover layer 2. For example, the UV light with a wavelength less than 365 nm. In particular, the UV light with a wavelength of 313 nm or 173 nm, or AP UV light. Partial irradiation with the UV light may be performed by utilizing, for example, a mask to block light beams. The mask may, for example, shield the entire area of the periphery region 12 from the UV light or just shield the area corresponding to the seal region 13 from the UV light as required.

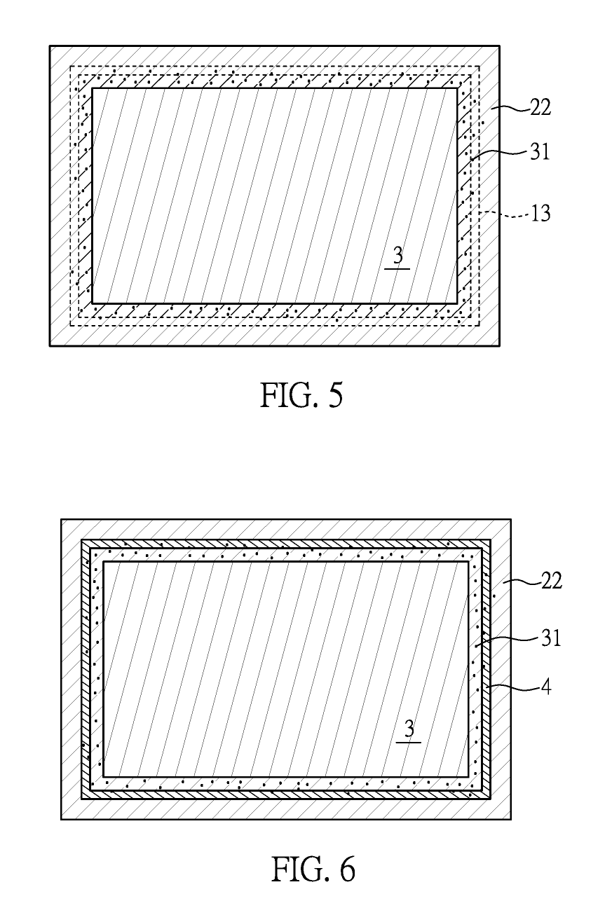

Next, referring to FIGS. 2 to 5, an alignment layer 3 is formed on the cover layer 2 corresponding to at least the display region 11, as shown in FIG. 5. In other words, the alignment layer 3 is formed on the cover layer 21 irradiated with the UV light corresponding to the display region 11. Due to good adhesion of the alignment material composition to the cover layer 21, an alignment layer can be well-formed after drying and curing. Meanwhile, due to poor adhesion of the alignment material composition to the cover layer 22, the alignment material composition from top of the cover layer 21 will not entirely overflow onto the cover layer 22 during the coating process. If the alignment material composition contacts the cover layer 22 at an edge of the cover layer 21, possibly including contacting the cover layer 22 corresponding to the seal region 13, the alignment material composition may at most attach onto the cover layer 22 in a few traces, including the cover layer 22 corresponding to the seal region 13. According to an embodiment of the present invention, the alignment material composition for forming the alignment layer 3 may be applied only to the cover layer 21 corresponding to the display region 11; or to the cover layer 21 corresponding to the display region 11 and the cover layers 21 and/or 22 corresponding to the periphery region surrounding the display region 11; or to the entire cover layer 2, for example, the cover layer 2 corresponding to all of the display region and the periphery region. Since the alignment material composition cannot adhere well to the cover layer 22 corresponding to the periphery region 12, including the seal region 13, it may only adhere to the cover layer 22 in a few traces. The trace or traces are in fact the alignment material composition. The trace or traces form one or more bumps 31 after drying and curing to form the alignment layer 3. In other words, the material of the bump or bumps 31 and the material of the alignment layer 3 are the same. The bump or bumps 31 may be one or more dots, or irregular-shaped fragments, or a combination thereof.

Conventionally, the entire cover layer is irradiated with UV light to change the adhesion property of the entire surface. Accordingly, the alignment material composition usually overflows from the cover layer corresponding to the display region and extends to the cover layer corresponding to the seal region to form an extension or extensions of alignment layer after drying and curing. However, different from the conventional overflow, the alignment material composition for forming the alignment layer 3 according to an embodiment of the present invention has poor adhesion to the cover layer 22 not irradiated with the UV light. Even if a portion of the alignment material composition attaches onto the cover layer 22 during the coating process, it may only present in a few traces and form one or a plurality of bumps 31 simultaneously when the alignment layer 3 is formed after drying and curing. The bump or bumps 31 may separately present on the cover layer 22 corresponding to the seal region 13 and may be separated from the alignment layer 3. In other words, the bump or bumps 31 may be in a form of island or islands. However, in other embodiments of the present invention, the cover layer 22 corresponding to the periphery region 12, including the seal region 13, may not form the bump or bumps 31 as mentioned above.

The alignment material composition herein means any known material that can be applied to substrates for forming an alignment layer. The alignment material composition may include, for example, any conventional alignment material and solvent. The alignment material may include, for example, polyimide and the like. The coating method may be, for example, distribution or printing (such as ink printing), but is not limited thereto. The coating layer may be dried, cured, and thereafter subjected to an alignment treatment such as brushing and rubbing or photoalignment depending on the properties of the alignment material, but is not limited thereto, to form the alignment layer. Since the conventional overflow issue will not be encountered in the present invention, the alignment material composition can be conveniently applied all over on the cover layer 2, including the cover layers 21 and 22. Accordingly, it is not necessary to utilize a printing plate, such as Asahi Photosensitive Resin (APR) plate, for printing and the fabrication process can be more convenient with less cost.

FIG. 6 is a schematic diagram showing a method for fabricating a display panel according to another embodiment of the present invention. Referring to FIGS. 2 to 5 and FIG. 6, the method for fabricating a display panel may further comprise a step of forming a sealant 4 on the cover layer 22 corresponding to the seal region 13 as shown in FIG. 6 after the alignment layer 3 is formed as shown in FIG. 5. In a liquid crystal display panel, the sealant 4 is for attachment of two substrates in order to seal the liquid crystal layer within the gap between the two substrates. Any conventional sealant material in this technical field can be utilized and applied to the cover layer 22 corresponding to the seal region 13 using any conventional coating method. One or more bumps 31 might form on the cover layer 22 corresponding to the seal region 13, but only in a few traces. The good adhesion of the sealant to the cover layer 22 on the seal region 13 will not be affected.

Herein, sealant distribution is performed on the substrate 1 as shown in FIG. 6. However, in other embodiments of the present invention (referring to FIG. 1 and FIG. 6), the same process can also be performed on the oppositely-disposed substrate 1′. Accordingly, the sealant 4 may form on the oppositely-disposed substrate 1′ or on both of the substrates 1 and 1′ other than only on the substrate 1 as shown in FIG. 6.

### Embodiment 2

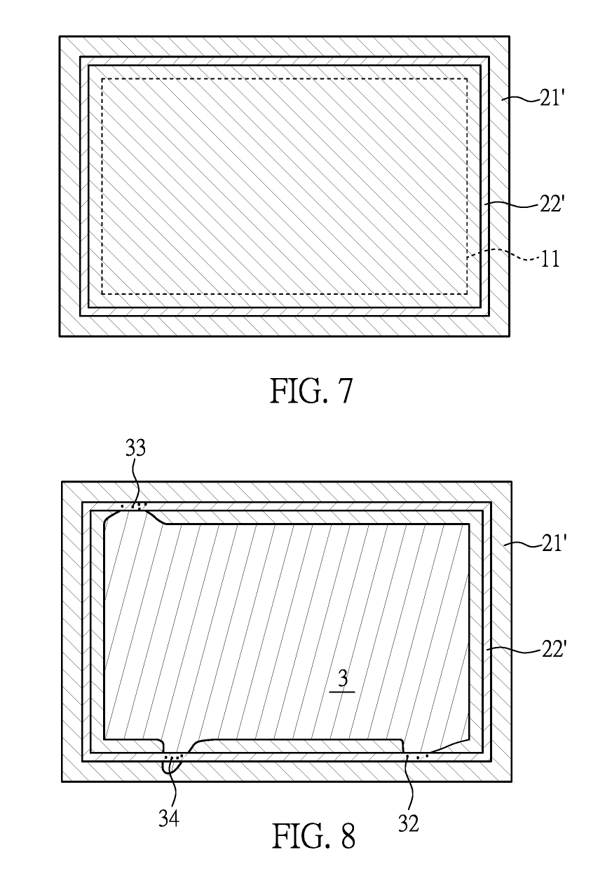

FIGS. 7 and 8 are schematic diagrams showing top views of a fabrication method of a display panel according to another embodiment of the present invention. After the cover layer 2 is formed on the substrate 1 in a way similar to Embodiment 1 shown in FIG. 3, a step of partially irradiating the cover layer 2 with the UV light is performed. Specifically, only the cover layer 2 corresponding to the seal region 13 is not irradiated with the UV light. The cover layer 2 corresponding to the display region 11 and the periphery region 12 other than the seal region 13 is irradiated with the UV light as shown in FIG. 7. The cover layer 21′ represents the cover layer 2 irradiated with the UV light and altered surface wettability. The cover layer 22′ represents the cover layer 2 not irradiated with the UV light.

Next, referring to FIG. 8, an alignment layer 3 is formed on the cover layer 21′ corresponding to the display region 11. In this embodiment, the alignment material composition is only applied to the cover layer 21′ corresponding to the display region 11 to form the alignment layer 3. However, since only the cover layer 22′ corresponding to the seal region 13 is not irradiated with the UV light, adhesion of the alignment material composition is only poor in this area. As a result, the alignment material composition from the cover layer 21′ corresponding to the display region 11 may attach onto the cover layer 21′ corresponding to the periphery region 12; or may attach onto the cover layer 22′ corresponding to the seal region 13; or may even attach onto the cover layer 21′ corresponding to the periphery region 12 surrounding the seal region 13. However, since the cover layer 22′ is not irradiated with the UV light and has poor adhesion to the alignment material composition, there might be only a few traces of the alignment material composition attach onto the cover layer 22′ to form one or a plurality of bumps 32, 33, and 34 after drying and curing. Or since area of the cover layer 22′ is small, the alignment material composition may not adhere to the cover layers 22′ and the aforesaid bumps will not form.

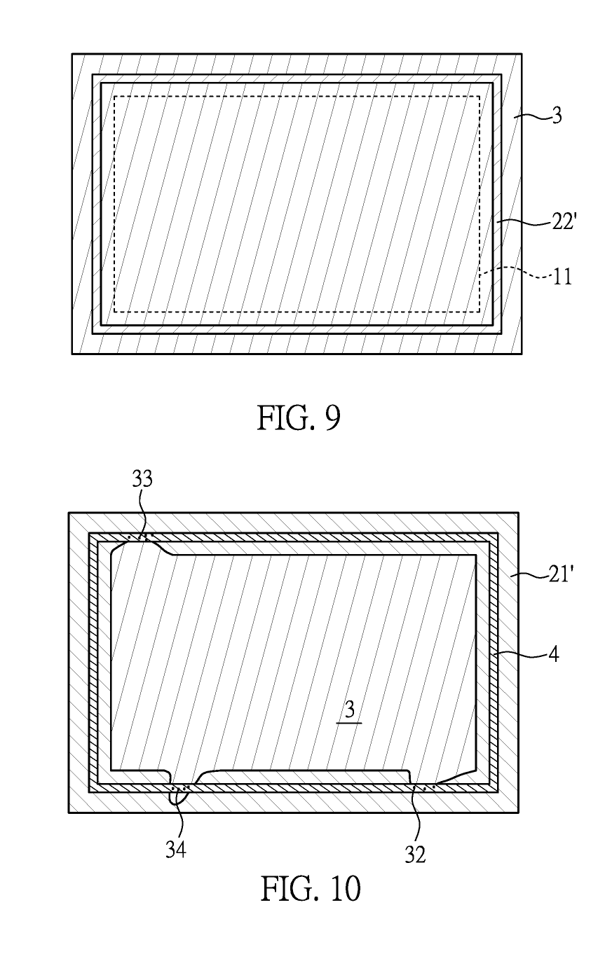

In another embodiment, after the step of only the cover layer 2 corresponding to the seal region 13 is not irradiated with the UV light as shown in FIG. 7, the alignment material composition may be applied to the cover layer 2 more conveniently. In other words, the alignment material composition may be conveniently applied to the entire cover layer 2 including the cover layers 21′ and 22′ corresponding to the entire display region 11 and the entire periphery region 12. After the alignment material composition is applied entirely, the alignment layer 3 will be formed according to the area irradiated with the UV light. In other words, as shown in FIG. 9, since it is difficult for the alignment material composition to adhere to the cover layers 22′ corresponding to the seal region 13, the alignment layer will not form thereon. Even if the alignment material composition can adhere thereto, the alignment material composition can at most adhere thereto in a few traces and form one or a plurality of bumps without forming alignment layer. As shown in FIG. 9, the alignment layer 3 may only form on the cover layer 21′ corresponding to the display region 11 and the periphery region 12 other than the seal region 13, and there may not be any bump formed from the alignment material composition on the cover layer 22′ corresponding to the seal region 13.

FIG. 10 is a schematic diagram showing a top view of a fabrication method of a display panel according to another embodiment of the present invention. Refer to FIGS. 2, 3, 7, 8, and 10. A method of forming a display panel according to an embodiment of the present invention, after the alignment layer 3 is formed, as shown in FIG. 8, may further comprise a step of forming a sealant 4 on the cover layer 22′ corresponding to the seal region 13 as shown in FIG. 10. The sealant material and the coating method are similar to those mentioned above and will not be described repeatedly for conciseness. In this embodiment, there may not be any bump formed on the cover layer 22′ corresponding to the seal region 13 or there may be one or a plurality of bumps 32, 33, and 34 formed thereon.

After the sealant is formed, a substrate assembling process can proceed to attach two corresponding substrates using the sealant to form the display panel according to an embodiment of the present invention as shown in FIG. 1.

As electronic products are being developed slimmer and lighter, the periphery region of the substrate is gradually narrowed. Accordingly, the distance from the seal region to the display region of the substrate is becoming shorter. As a result, in conventional alignment layer formation process, overflow of alignment material composition as mentioned above tends to occur. A portion of sealant will form on the alignment layer affecting the sealing quality of subsequent substrate assembling. In the method for fabricating a display panel according to an embodiment of the present invention, since the alignment material composition cannot adhere easily to the cover layer not irradiated with the UV light on the seal region, the aforesaid problem can be avoided and the product reliability can thereby be improved. The display panels provided by an embodiment of the present invention may be liquid crystal display panels having an alignment layer formed on a cover layer and manufactured from substrate assembling process through a sealing process. The type of liquid crystal display panels may be, for example, twisted nematic (TN), super twisted nematic (STN), vertical alignment (VA), in-plane switching (IPS), fringe field switching (FFS), and others, but not limited thereto. The function and advantage of an embodiment of the present invention will be more significant for narrow-framed display panels.

It should be clearly understood that the embodiments described above are illustrative only and it is not intended to limit the scope of the present invention.

What is claimed is:

1. A method for fabricating a display panel, comprising:
providing a substrate comprising a display region and a periphery region, wherein the periphery region is outside the display region and the periphery region comprises a seal region;
forming a cover layer on the display region and the periphery region of the substrate;
irradiating the cover layer with UV light corresponding to the display region and not irradiating the cover layer with the UV light corresponding to at least one portion of the seal region; and
forming an alignment layer at least on the cover layer corresponding to the display region.

2. The method according to claim 1, wherein the cover layer corresponding to the entire seal region is not irradiated with the UV light.

3. The method according to claim 1, after forming the alignment layer, further comprising: disposing a sealant on the cover layer corresponding to the seal region.

4. The method according to claim 1, wherein the alignment layer is further formed on the periphery region other than the seal region.

5. The method according to claim 1, wherein when the alignment layer is formed on the cover layer corresponding to at least the display region, at least one bump is further formed on the seal region and a material of the alignment layer and a material of the at least one bump are the same.

6. A display panel, comprising:
a substrate comprising a display region and a periphery region, wherein the periphery region is outside the display region and the periphery region comprises a seal region;
a cover layer on the display region and the periphery region of the substrate;
an alignment layer on the cover layer corresponding to the display region;
at least one bump on the periphery region, and a material of the alignment layer and a material of the at least one bump are the same; and
a sealant on the cover layer corresponding to the seal region.

7. The display panel according to claim 6, wherein the sealant further covers all or a part of the at least one bump.

8. The display panel according to claim 6, wherein the at least one bump is one or a plurality of dots, or irregular-shaped fragments, or a combination thereof.

9. A display panel, comprising:
a substrate comprising a display region and a periphery region, wherein the periphery region is outside the display region and the periphery region comprises a seal region;
a cover layer on the display region and the periphery region of the substrate;
an alignment layer on the cover layer corresponding to the display region and further on the periphery region other than the seal region; and
a sealant on the cover layer corresponding to the seal region.

10. The display panel according to claim 9, further comprising at least one bump on the seal region, wherein a material of the alignment layer and a material of the at least one bump are the same, and the sealant further covers the at least one bump.
